(19) United States
(12) Patent Application Publication
(10) Pub. No.: US 2007/0136214 A1
(43) Pub. Date: Jun. 14, 2007

(54) Method for managing consumable material

(76) Inventor: Fetneh Eskandari, East Hampton, CT (US)

Correspondence Address: PERMAN & GREEN, 425 POST ROAD, FAIRFIELD, CT, 06824, US

(21) Appl. No.: 11/242,104

(22) Filed: Oct. 3, 2005

(51) Int. Cl. G06F 17/00

(52) U.S. Cl. 705/408

(57) ABSTRACT

A method for managing consumable material required to produce an indicia on pieces of markable material. The method is provided having the steps of: providing a device having consumable material, the device adapted to produce the indicia with the consumable material; providing a central location; connecting the device to the central location through a connection; measuring the amount of consumable material at the device; notifying the central location through the connection when the amount of consumable material measured reaches a predetermined level; and replenishing the material for the device.

### BACKGROUND

1. Field

The exemplary embodiments and methods described herein relate to a method for managing consumable material required to produce an indicia on pieces of markable material.

2. Brief Description of Related Developments

Markable materials such as mail pieces or other printed materials may be generated with indicia produced by devices such as mailing machines or printers. One example of such indicia includes printed matter on paper. Another example of such indicia includes indicia produced by mailing machines or on mail such as originator, destination and return address or stamped indicia. Mailing machines enable users to frank one or more mail items by printing a stamp representing the amount paid by the sender. For example, U.S. Pat. No. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples. A problem arises when the consumable material, such as ink, is consumed and an inconsistent supply prevents a user form continuously operating the printing device. A further problem arises when the user is not aware that the device is running low or ran out if the consumable material. Accordingly, there is a desire to provide a managed and substantially continuous supply of consumable material required to produce indicia on pieces of markable material.

### SUMMARY OF THE EXEMPLARY EMBODIMENTS

In accordance with one exemplary embodiment of the present invention, a method of managing consumable material required to produce indicia on pieces of markable material is provided having steps of: providing a device having consumable material, the device adapted to produce the indicia with the consumable material; providing a central location; connecting the device to the central location through a connection; measuring the amount of consumable material at the device; notifying the central location through the connection when the amount of consumable material measured reaches a predetermined level; and replenishing the material for the device.

In accordance with another exemplary embodiment of the present invention, a method of managing consumable material required to produce indicia on pieces of markable material is provided having steps of: providing a device having consumable material, the device adapted to produce the indicia with the consumable material; providing a central location; connecting the device to the central location through a connection; measuring an amount of consumable material at the device; and providing data from the device to the central location based upon the amount of consumable material at the device.

In accordance with another exemplary embodiment of the present invention, a method of maintaining a substantially continuous supply of consumable ink required to produce indicia on pieces of mail is provided having steps of: providing a mailing machine having the consumable ink, the mailing machine adapted to produce the indicia with the consumable ink; providing a remote server; connecting the mailing machine to the remote server through a connection; measuring an amount of consumable ink at the mailing machine; providing an alert when the amount of consumable ink measured reaches a predetermined level; providing data from the mailing machine to the remote server based upon the amount of consumable ink measured at the mailing machine; and replenishing the consumable ink for the device.

### BRIEF DESCRIPTION OF THE DRAWINGS

The foregoing aspects and other features of the present invention are explained in the following description, taken in connection with the accompanying drawings, wherein:

FIG. 1 shows a prior art addressed envelope;

FIG. 2 shows a block diagram of a system in which the method of the present invention could be utilized; and

FIG. 3 shows a block diagram of a printing device in which the method of the present invention could be utilized.

### DETAILED DESCRIPTION OF THE EXEMPLARY EMBODIMENTS

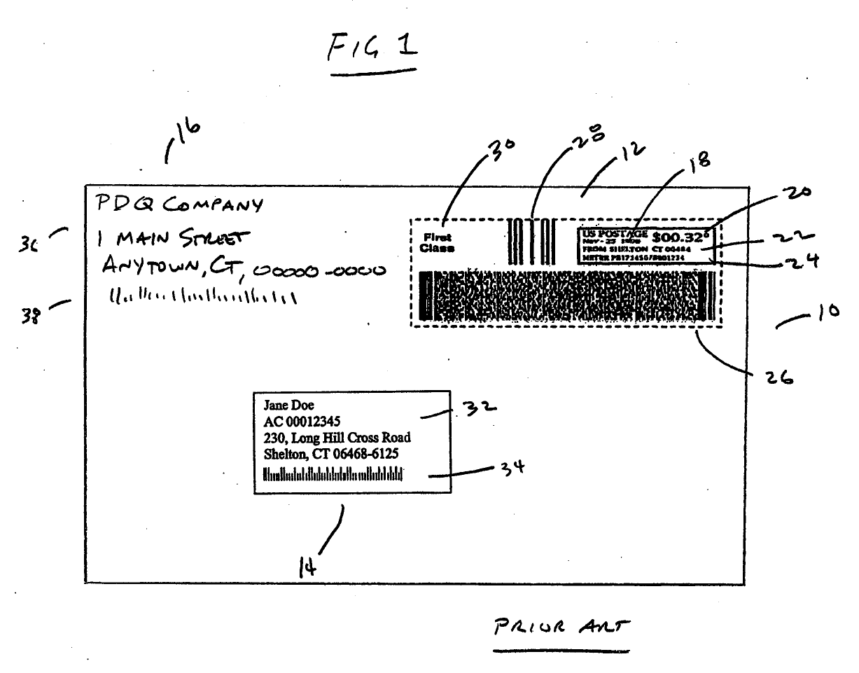

Referring to FIG. 1, there is shown markable material 10, such as an envelope. In alternate embodiments, markable material 10 may be any suitable material such as paper or otherwise. Envelope 10 may have indicia, such as United States Postal Service (USPS) Information Based Indicia (IBI) 12, a destination address 14 and a return address 16. The indicia 12 has a date 18, a dollar amount 20, place of origin 22 postal meter serial number 24, encrypted bar code 26 and FIM 28 and class indication 30. The destination address 14 includes a written destination 32 and bar code 34 corresponding to the written destination 32. The return address 16 includes a written return 36 and bar code 38 corresponding to the written return 36. Although the present invention will be described with reference to the exemplary embodiments shown in the drawings, it should be understood that the present invention can be embodied in many alternate forms of embodiments. In addition, any suitable size, shape or type of elements or materials could be used.

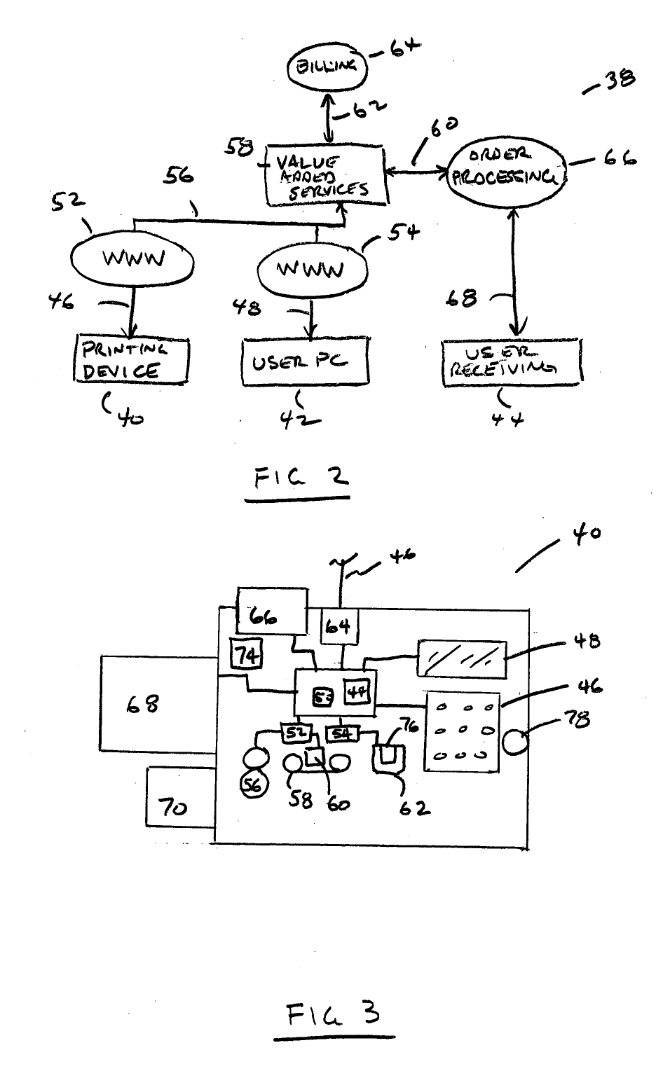

Referring now to FIG. 2, there is shown a block diagram of a system 38 in which the method of the present invention could be utilized. Markable material, such as mail piece 10 is originated by a user at device 40 where indicia, such as destination address, return address, delivery type and/or an IBI code and printed on the mail piece at 10. Device 40 may be a printer, franking machine or other applicable device having consumable material, such as ink for example. In alternate embodiments, device 40 and the associated markable material may be any suitable device having consumable materials for marking the markable material, for example, an RF Tag deposition machine where the markable material is material to be tagged and/or tracked. Data may be stored at device 40 or transferred from device 40 to a value added services application 58, for example, transferred over the world wide web 52 to value added service application 58 on a server 58. In alternate embodiments, data may be collected and/or processed further up or down stream of Device 40 and services application 58. Network connections 46, 56 are provided and may be any suitable network, such as a local area network, wireless network or otherwise. In alternate embodiments, the data may be stored locally or stored over a network where value added services 58 does not require access over web 52 and where value added services application 58 does not reside on device 40. In alternate embodiments, additional data may be transferred, for example, where a user such as the originator or a postal service may access the data from value added services application 58 over network 48, 56 via user PC 42. Alternately, the data may be posted to a website and accessed by application 58 or PC 42 via web 52, 54. A billing link 62, 64 may be provided to track and bill for user access to service application 58. Alternately, the function of billing link 64 may be provided as part of application 58. An order processing link 60, 66 may be provided to process and fulfill orders for consumable materials resulting in delivery 68 and receipt of the consumable materials by the user. Alternately, the function of link 66 may be provided as part of application 58. Although the different functions and data access points are shown linked by the world wide web, other suitable access or data communication methods may be provided, for example, networked or wireless or other suitable methods. System 38 may be utilized in methods whereby a substantially continuous supply of consumable material may be provided to device 40. These methods may enable management of any material that is needed, for example, to produce a mark on a paper in device 40. Here, the consumable material may be measured in device 40 by any suitable approach based on the mechanism employed by device 40 to produces the mark. For example, the material may be ink and device 40 may utilize an ink jet printer head as in a mailing device. The amount of ink used for producing the indicia in the mailing system may be measured, for example, by counting drops where the level has reached a predetermined level, device 40 may produce an alert message and display the message on the device. Here, the customer can initiate a manual ordering process. In addition, the device may produce an alert to be transferred to application 58 at a central location 58 at the time of the connection 46 to application 58. Here, connection 46 may be real time, scheduled by device 40 or by remote center or application 58. Here, application 58 may be running on a remote server and receives the alert. Upon receipt, a number of actions may be triggered by application 58, such as initiating an order or dispatching notification e-mails to a user accessible at 42. The method may apply to information printed during a maintenance cycle as well as any other information in addition to the indicia. For example, information or data relating to frequency of printing, device utilization, consumable material usage rates and utilization, destination or origination or otherwise. Here, any data pertaining to the use of consumable materials may be provided to either reactively or predictable determine when replenishment is necessary and/or at what rate and time it is needed such that a substantially continuous supply of consumable material may be provided for device 40. In alternate embodiments, more or less devices 40 with different consumables may be provided. In alternate embodiments, more or less users, applications or networks may be provided. In alternate embodiments, other materials or applications may be provided. For example, the consumable material may be an RF tag and the device may be a printer that applies the RF tag to envelopes in the RF tag printer. Here, the number of tags in the printer 40 may be measured and as the number approaches a predetermined level or number, the device 40 will produce an alert to be transferred to the central location 58 at the time of the connection. The connection may be real time, scheduled by the device or by the remote center. Once the remote server receives the alert, a number of actions may be triggered, such as initiating an order, dispatching e-mails, or otherwise. In alternate embodiments, device 40 may provide data relating to consumable material usage to value added service application 58 where application 58 tracks consumption, utilization or otherwise and, in a predictive manner, determines when the consumable needs to be replenished. Alternately, an alert may be generated automatically in the server based on the number of RF tags already used. Here, the number may be calculated by the information sent from the remote device to the remote center in transaction uploads. In each case, data may be tracked, transferred, accessed or utilized in any suitable manner, such as disclosed in U.S. patent application Ser. No. 11/047,286 filed Jan. 31, 2005 which is hereby incorporated by reference in its entirety.

In this manner, a method of managing consumable material required to produce indicia on pieces of markable material 10 is provided having the following steps: a. providing a device 40 having consumable material, the device 40 being adapted to produce the indicia with the consumable material; b. providing a central location 58; c. connecting the device 40 to the central location through a connection 46; d. measuring the amount of consumable material at the device 40; e. notifying the central location 58 through the connection 46 when the amount of consumable material measured reaches a predetermined level; and f. replenishing the material for the device 40. The device 40 may comprise a printer head in a franking device and the markable material may comprises mail where the consumable material may comprises ink. The step of measuring the amount of consumable material at the device 40 may comprise measuring the amount of ink deposited by the printer head. A step may be provided of providing an alert message to a user when the amount of material measured reaches the predetermined level where the alert message is provided from the device 40. Alternately, the alert message may be provided from the central location 58, where the central location 58 is a remote server. Alternately, the consumable material may comprise an RF tag, where the step of measuring the amount of consumable material at the device comprises measuring the number RF tags consumed, where the device 40 comprises an RF tag printer head, and where the markable material comprises mail. The central location 58 may comprise a remote server, where the device 40 comprises a mailing machine, and where the step of notifying may comprise the steps of providing an alert message from the mailing machine to the remote server and providing an e-mail alert to a user.

Alternately, a method of managing consumable material required to produce indicia on pieces of markable material is provided having the following steps: a. providing a device 40 having consumable material, the device 40 adapted to produce the indicia with the consumable material; b. providing a central location 58; c. connecting the device 40 to the central location 58 through a connection 46; d. measuring an amount of consumable material at the device 40; and e. providing data from the device to the central location 58 based upon the amount of consumable material at the device 40. The data may comprise an alert notifying the central location 58 through the connection 46 when the amount of consumable material measured reaches a predetermined level. The connection 46 may be real time, scheduled by the device 40 or scheduled by the central location 58. The data may comprise the amount of consumable material consumed at the device where the central location 58 determines when the material needs to be replenished. The central location 58 may track the rate at which consumable material is consumed at the device 40, where the central location 58 predictably determines when the material needs to be replenished, and where the device 40 may be replenished with a substantially continuous supply of consumable material.

Alternately, a method of maintaining a substantially continuous supply of consumable ink required to produce indicia on pieces of mail is provided having the following steps: a. providing a mailing machine 40 having the consumable ink, the mailing machine 40 adapted to produce the indicia with the consumable ink; b. providing a remote server 58; c. connecting the mailing machine 40 to the remote server 58 through a connection 46; d. measuring an amount of consumable ink at the mailing machine 40; e. providing an alert when the amount of consumable ink measured reaches a predetermined level; e. providing data from the mailing machine 40 to the remote server 58 based upon the amount of consumable ink measured at the mailing machine 40; and f. replenishing the consumable ink for the device 40. Here, the data may comprise the alert. Additionally, a step of dispatching a replenishment alert e-mail to a user may be provided. Additionally, a step of displaying a replenishment alert at the mailing machine may be provided. The remote server 58 may initiate an order to replenish the consumable ink.

Referring now to FIG. 3, device 40 may be a mailing machine. In the embodiment shown, mailing machine 40 generally comprises a franking device 42. The mailing machine 40 and its sections described in greater detail below is merely exemplary, and in alternate embodiments the mailing machine may have any other sections or systems. Mailing machine 40 generally has microprocessor 44 which effects operation of the franking machine. A user interface, such as a keyboard 46 may be provided to input data by a user. Display 48 may be provided to display status or other information as to the operation of mailing machine 40. Memory 50 may be provided to store data. Controllers 52, 54 may be provided for driving items such as feeder 56 or marking device, such as ink ribbon 58 or impression roller and raise/lower drive 60 or print element 62. In alternate embodiments, the mailing machine may have any other suitable marking means such as an ink jet head or laser printing head. Print element 62 may have an ink cartridge and may be provided to print mail indicia on mail items as they are fed or as an alternate to an impression roller. Additional peripheral devices, such as modem or network connection 64, scale 66, folder 68, insertion device 70, moistener/sealer 72, label dispenser 74, speaker device 78, or other peripheral devices may be provided. As an example where the consumable material is ink, a detection apparatus 76 may be provided to monitor the level, consumption or other aspects relating to the consumable material, in this case, ink. Detection apparatus 76 provides data to processor 44. Processor 44 may then provide the raw data to connection 46 via network interface 64. Alternately, processor 44 may manipulate the data and provide logic, such as to trigger an alarm upon detection apparatus reaching a predetermined level. Here, in addition to the methods above, processor 44 or server 58 may take additional action, such as providing alarms or adjusting or modify amount of ink/gray scale with ink rationing, such as disclosed in U.S. Pat. No. 6,761,422 which is hereby incorporated by reference in its entirety. Detection apparatus 76 may comprise any suitable detection device. For example, sensing element 76 may be adapted to detect ink droplets ejected from an ink drop generator such as integrated into an ink jet print head such as disclosed in U.S. Pat. No. 6,769,756 which is hereby incorporated by reference in its entirety. In alternate embodiment, continuous monitoring sensors, such as optical sensors as disclosed in U.S. Pat. No. 6,893,118 which is hereby incorporated by reference in its entirety may be employed. Alternately, a signal may be generated when predetermined levels are reached in the cartridge where level sensors 76 are discrete sensors that generate a signal when the level of print material reaches a predetermined level. Here, the controller may monitor the signals from the discrete sensors for example in U.S. Pat. No. 6,792,216, 6,848,762 which is hereby incorporated by reference in its entirety. Alternately level indication may be determined by calculating the amount of printed material deposited, such as with the print data files such as disclosed in U.S. Pat. No. 6,856,430, 6,871,926 and 6,863,364 which are hereby incorporated by reference in its entirety. Alternately, printing parameters may be tracked to determine ink consumption, such as disclosed in U.S. Pat. No. 6,893,108 which is hereby incorporated by reference in its entirety. As noted before, the machine 40 shown in FIG. 3 and described above is merely exemplary and not meant to be the exclusive embodiment. For example, in alternate embodiments, device 40 may comprise a conventional printer for printing on paper. In alternate embodiments, more or less features may be provided, such as where more, less or different components are provided. Further, for example, a wireless or computer interface could be provided, or a battery may be disposed within mailing machine 40. As yet a further example, a custom message interface could be provided or docking interfaces, power interface, status indicators, other connections, labels, network connections, additional user interfaces, or otherwise may be provided.

It should be understood that the foregoing description is only illustrative of the invention. Various alternatives and modifications can be devised by those skilled in the art without departing from the invention. One such example is where other configurations of databases or servers may also be used. Accordingly, the present invention is intended to embrace all such alternatives, modifications and variances which fall within the scope of the appended claims.

What is claimed is:

1. A method of managing consumable material required to produce indicia on pieces of markable material, the method comprising the steps of:
a. providing a device having consumable material, the device adapted to produce the indicia with the consumable material;
b. providing a central location;
c. connecting the device to the central location through a connection;
d. measuring the amount of consumable material at the device;
e. notifying the central location through the connection when the amount of consumable material measured reaches a predetermined level; and
f. replenishing the material for the device.

2. The method of claim 1, wherein the device comprises a printer head in a franking device, and wherein the markable material comprises mail.

3. The method of claim 2, wherein the consumable material comprises ink, and wherein the step of measuring the amount of consumable material at the device comprises measuring the amount of ink deposited by the printer head.

4. The method of claim 1 further comprising the step of providing an alert message to a user when the amount of material measured reaches the predetermined level.

5. The method of claim 4, wherein the alert message is provided from the device.

6. The method of claim 4, wherein the alert message is provided from the central location, and wherein the central location is a remote server.

7. The method of claim 1, wherein the consumable material comprises an RF tag, and wherein the step of measuring the amount of consumable material at the device comprises measuring the number RF tags consumed, and wherein the device comprises an RF tag printer head, and wherein the markable material comprises mail.

8. The method of claim 1 wherein the central location comprise a remote server, and wherein the device comprises a mailing machine, and wherein the step of notifying comprises the steps of:
a. providing an alert message from the mailing machine to the remote server; and
b. providing an e-mail alert to a user.

9. A method of managing consumable material required to produce indicia on pieces of markable material, the method comprising the steps of:
a. providing a device having consumable material, the device adapted to produce the indicia with the consumable material;
b. providing a central location;
c. connecting the device to the central location through a connection;
d. measuring an amount of consumable material at the device; and
e. providing data from the device to the central location based upon the amount of consumable material at the device.

10. The method of claim 9, wherein, the data comprises an alert notifying the central location through the connection when the amount of consumable material measured reaches a predetermined level.

11. The method of claim 9, wherein the connection is real time.

12. The method of claim 9, wherein the connection is scheduled by the device.

13. The method of claim 9, wherein the connection is scheduled by the central location.

14. The method of claim 9, wherein the data comprises the amount of consumable material consumed at the device, and wherein the central location determines when the material needs to be replenished.

15. The method of claim 14, wherein the central location tracks the rate at which consumable material is consumed at the device, and wherein the central location predictably determines when the material needs to be replenished, and wherein the device is replenished with a substantially continuous supply of consumable material.

16. A method of maintaining a substantially continuous supply of consumable ink required to produce indicia on pieces of mail, the method comprising the steps of:
a. providing a mailing machine having the consumable ink, the mailing machine adapted to produce the indicia with the consumable ink;
b. providing a remote server;
c. connecting the mailing machine to the remote server through a connection;
d. measuring an amount of consumable ink at the mailing machine;
e. providing an alert when the amount of consumable ink measured reaches a predetermined level;
f. providing data from the mailing machine to the remote server based upon the amount of consumable ink measured at the mailing machine; and
g. replenishing the consumable ink for the device.

17. The method of claim 16, wherein the data comprises the alert.

18. The method of claim 16 further comprising the step of dispatching a replenishment alert e-mail to a user.

19. The method of claim 16 further comprising the step of displaying a replenishment alert at the mailing machine.

20. The method of claim 16, wherein the remote server initiates an order to replenish the consumable ink.
